(19) United States
(12) Patent Application Publication
(10) Pub. No.: US 2010/0326387 A1
(43) Pub. Date: Dec. 30, 2010

(54) Expanding the operating envelope of advanced combustion engines using fuel-alcohol blends

(75) Inventors: Lisa I. Yeh, Marlton, NJ (US); Alan M. Horowitz, Cherry Hill, NJ (US)

Correspondence Address: ExxonMobil Research & Engineering Company, P.O. Box 900, 1545 Route 22 East, Annandale, NJ, 08801-0900, US

(73) Assignee: ExxonMobil Research and Engineering Company, Annandale, NJ (US)

(21) Appl. No.: 12/799,037

(22) Filed: Apr. 16, 2010

Related U.S. Application Data
(60) Provisional application No. 61/269,856, filed on Jun. 30, 2009.

(51) Int. Cl. F02B 43/00

(52) U.S. Cl. 123/1 A

(57) ABSTRACT

The invention provides methods that expand the operating envelope of advanced combustion engines during operation in an advanced combustion mode by supplying an engine cylinder during operation in the advanced combustion mode with fuel-alcohol blends, e.g. gasoline-alcohol blends. In methods of the invention, fuel-alcohol blends combust efficiently over a wide range of engine loads, and the need for EGR, VVT, NVO, rebreathing, or multiple fuel injection is either reduced or eliminated.

### CROSS REFERENCE TO RELATED APPLICATION

This Application claims the benefit of U.S. Provisional Application 61/269,856 filed Jun. 30, 2009.

This Application claims the benefit of U.S. Provisional Application 61/269,856 filed Jun. 30, 2009.

### FIELD OF THE INVENTION

The invention provides thermally-efficient and environmentally-friendly methods for expanding the operating envelope of advanced combustion engines.

### BACKGROUND OF THE INVENTION

Internal combustion (IC) engines can operate in a spark ignition (SI) mode, in which a nearly homogeneous air and fuel charge is spark-ignited within a combustion chamber. IC engines may also operate in a compression ignition mode, in which compression of a non-homogeneous air and fuel charge within a combustion chamber ignites the charge. Homogeneous charge compression ignition (HCCI) is a type of compression ignition in which air and fuel are thoroughly mixed in an engine cylinder before compression-initiated self-ignition. Worldwide regulatory initiatives to lower vehicular nitrogen oxides (NOₓ) and particulate matter (PM) emission levels have heightened interest in HCCI, as HCCI can combine the low-NOₓ exhaust emissions of gasoline engines with three-way catalysts with the high thermal efficiency associated with diesel engines.

In HCCI, enhanced air-fuel mixing occurs generally through direct fuel injection at an earlier stage than diesel fuel injection. Unlike conventional diesel combustion, HCCI combustion results from spontaneous auto-ignition at multiple points throughout the volume of charge gas. HCCI combustion typically occurs in two stages. A low temperature heat release (LTHR) occurs first, followed by a high temperature heat release (HTHR). LTHR50 is the time at the mid-point of LTHR and HTHR50 is the time at the mid-point of HTHR.

Broadening LTHR and HTHR, and reducing the maximum rate of pressure increase during LTHR and HTHR, increases the operating range of a HCCI engine. Yao, et al., “An investigation on the effects of fuel chemistry and engine operating conditions on HCCI engine”, SAE Technical Paper Series 2008-01-1660; Lu, et al., “Experimental study and chemical analysis of n-heptane homogeneous charge compression ignition combustion with port injection of reaction inhibitors”, Combustion and Flame 149 (2007) 261-270.

While these attributes of HCCI are known, it has still proven difficult to operate HCCI engines over a wide range of loads for a number of reasons.

Since HCCI engines rely on auto-ignition, combustion phasing (the timing of auto-ignition) is inherently difficult to control. The rapid rate of heat release by a HCCI engine as its load increases can lead to mechanical and noise problems. Also, combustion occurs very rapidly in HCCI engines and the maximum rate of pressure rise limits the ability of HCCI engines to achieve medium and high loads. HCCI is also sensitive to fuel composition, Shibata, et al., “Correlation of Low Temperature Heat Release with Fuel Composition and HCCI Engine Combustion”, SAE Technical Paper Series 2005-01-0138, and fuels often do not auto-ignite at low loads.

Although external exhaust gas recirculation (EGR) and variable valve timing (VVT) help to control the combustion heat release, rate of pressure rise, and NOₓ emissions of HCCI and other IC engines, each of these design options has its detriments.

External EGR leads to a slow response rate since EGR gases must flow through the exhaust and EGR system. External EGR also requires substantial heat dissipation; EGR must often be cooled prior to introduction into the engine. Further, to achieve high load performance with EGR, a larger engine size is needed (due to the displacement of air by EGR), which leads to a loss of efficiency and power. While internal EGR strategies using VVT have faster response rates, these valve strategies contend with delayed intake valve closure time, which also decreases power and efficiency.

Negative Valve Overlap (NVO) attempts to solve HCCI's low load auto-ignition problem by using early exhaust valve closing to trap burnt gases. The trapped gases assist with auto-ignition during a subsequent compression stroke. In another approach called re-breathing, the exhaust valve reopens during the intake stroke to allow burnt gases to reenter the cylinder from the exhaust port. Multiple fuel injection has also been used in an effort to optimize fuel composition and load conditions.

Notwithstanding the aforementioned efforts to optimize advanced combustion engine combustion phasing and emission levels, the need continues to exist for methods that will enable IC engines to operate in an advanced combustion mode (e.g. HCCI mode) in a more environmentally-sound, thermally-efficient, and economically-viable manner. Ideally, such methods would operate effectively at high and low engine loads, would achieve improved peak NOₓ and PM emission levels, and would enhance thermal efficiency without the mechanical complexities and thermal inefficiencies associated with known engine designs.

### SUMMARY OF THE INVENTION

We have discovered methods that expand the operating envelope of advanced combustion engines during operation in an advanced combustion mode by supplying an engine cylinder during operation in the advanced combustion mode (e.g. HCCI mode) with fuel-alcohol blends (e.g. gasoline-blends having a (RON+MON)/2 value of between about 85 to about 100). In the methods described herein, fuel-alcohol blends combust efficiently over a wide range of engine loads, and the need for EGR, VVT, NVO, rebreathing, multiple fuel injection, and inlet cylinder pressure boosting is either reduced or eliminated. Methods of the invention exhibit (1) significantly is reduced peak NOₓ emission levels (2) prolonged ignition delay (3) delayed and broadened HTHR, and (4) reduced maximum rates of pressure increase during HTHR.

Given their improved combustion characteristics, the methods described herein enable advanced combustion engines to operate in an advanced combustion mode (e.g. HCCI mode) over a broad range of speeds and loads. For example, the methods described herein should expand an engine's HCCI load range by about 10% to about 30% without encountering unacceptable engine noise, metallurgical stress, or elevated NOₓ emission levels. Because of their thermal efficiency and low NOₓ emission levels, the methods described herein offer substantial environmental advantages.

In one embodiment, the methods described herein provide a method of expanding an advanced combustion engine's operating envelope by supplying an engine cylinder during operation in an advanced combustion mode (e.g. HCCI mode) with a gasoline-alcohol blend that has a (RON+MON)/2 value of between about 85 to about 100 and that comprises about 5% or more by volume of an alcohol, wherein during operation in the advanced combustion mode (e.g. HCCI mode) (1) the engine's peak NOₓ emission level is between about 5% to about 99% lower than the peak NOₓ emission level generated by combustion of a reference gasoline under equivalent combustion conditions; and (2) the engine cylinder optionally contains a small percentage by volume of EGR prior to combustion of the gasoline-alcohol blend in the cylinder.

The methods described herein can use blends in which an alcohol and a fuel, e.g. a gasoline, are blended before introduction into an engine cylinder. Alternatively, an alcohol and a fuel (e.g. a gasoline) may be supplied (e.g., injected) separately into the cylinder to form a blend containing the requisite amounts of alcohol and fuel.

The methods described herein achieve efficient combustion over a wide range of engine speeds and loads. Because of delayed ignition and delayed and broadened HTHR, combustion is more uniform throughout the engine's cylinders under high load conditions where larger amounts of fuel are fed to the cylinder. Also, combustion stability is improved and cycle-to-cycle variability is reduced.

These and other aspects of the invention are described further in the following detailed description of the invention.

### BRIEF DESCRIPTION OF THE DRAWINGS

FIG. 1 illustrates the differences between LTHR50 and HTHR50 for the base (ethanol-free) and ethanol-containing fuels tested in the combustion experiments of Examples 1-2.

FIG. 2 illustrates the effect of ethanol on cycle average peak NOₓ emission levels for the base (ethanol-free) and ethanol-containing fuels tested in the combustion experiments of Examples 1-2.

FIG. 3 illustrates the effect of ethanol on individual cycle peak NOₓ emission levels for the base (ethanol-free) and ethanol-containing fuels tested in the combustion experiments of Examples 1-2.

FIG. 4 illustrates an advanced combustion engine's HCCI operating envelope.

FIG. 5 and FIG. 6 illustrate heat release data for combustion of ethanol-enriched gasoline in accordance with the methods described herein.

### DETAILED DESCRIPTION OF THE INVENTION

Unless otherwise stated, all percentages disclosed herein are on a volume basis.

Any end point of a range stated herein can be combined with any other end point to form another suitable range.

The following definitions apply unless indicated otherwise.

“An advanced combustion engine” means an IC engine which operates, at least under some speed/load conditions, in either (1) a truly homogeneous HCCI mode (2) a premixed charged compression ignition (PCCI) mode (3) a low-temperature combustion (LTC) mode, or (4) another nontraditional highly mixed combustion mode.

“An alcohol” as used herein includes either one alcohol or a mixture of two or more alcohols. Monohydric aliphatic alcohols are used in certain aspects. Alcohols which contain from 1 to about 10 carbon atoms are used in certain aspects, alcohols containing from 1 to 5 carbon atoms are used in certain aspects, and alcohols containing from 1 to 4 carbon atoms are used in certain aspects. For example, an “alcohol” can be comprised of one or more compounds selected from the group consisting of methanol, ethanol, 1-propanol, 2-propanol, 1-butanol, 2-butanol, 2-methyl-1-propanol, and 2-methyl-2-propanol. Methanol and ethanol are used in certain aspects, and ethanol is used in certain aspects.

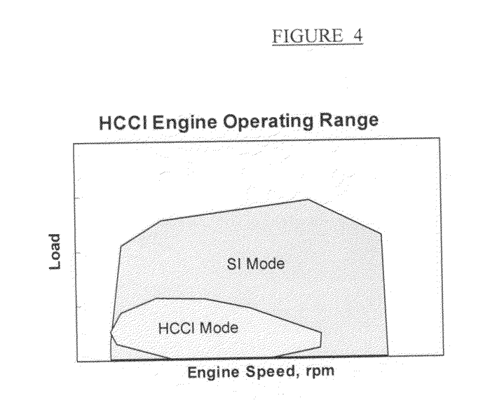

An “advanced combustion engine's operating envelope” (e.g. an engine's HCCI operating envelope) is defined by the speed and load range under which the engine is able to operate in the advanced combustion mode, e.g. as depicted for HCCI combustion mode in FIG. 4. An advanced combustion engine's operating envelope is delimited by one or more parameters such as acceptable engine noise, acceptable engine metallurgical stress, and misfire.

“Expanding an advanced combustion engine's operating envelope during operation in an advanced combustion mode” (e.g. expanding an engine's HCCI operating envelope) means increasing the speed and/or load range under which the engine is able to operate in the advanced combustion mode by using a fuel-alcohol blend, e.g. a gasoline-alcohol blend. For example, the methods described herein should expand an engine's HCCI operating envelope to include loads that are about 10% to about 30% higher than the loads achieved when the engine uses a reference gasoline.

“The engine cylinder optionally contains a small percentage by volume of EGR prior to combustion of the gasoline-alcohol blend in the cylinder” means that the engine cylinder contains less than 40% by volume of EGR, and in some aspects less than 20% by volume of EGR.

A “fuel” as described herein includes, but is not limited to, a gasoline, a diesel fuel, kerosene, a jet fuel, a biofuel blend (e.g. biodiesel), a renewable diesel, a Fischer-Tropsch derived fuel, a gasoline-diesel blend, a naphtha, other fuels derived from petroleum or non-petroleum feed stocks, and any combination or blend of the forgoing. Fuels, as described in this disclosure, typically contain additives to improve performance or meet regulations. Examples of additives that might be included in minor amounts in the above mentioned fuels include, but are not limited to oxygenates, detergents, dispersants, lubricity agents, cetane improvers, cold flow improvers, metal deactivators, demulsifiers, defoamants, dyes, corrosion inhibitors and the like.

A non-limiting example of “gasoline” comprises a mixture of hydrocarbons that boil at atmospheric pressure in the range of about 77° F. (25° C.) to about 437° F. (225° C.). and that comprise a major amount of a mixture of paraffins, cycloparaffins (cycloparaffins), olefins and aromatics, and lesser or minor amounts of additives including oxygenates, detergents, dyes, corrosion inhibitors and the like.

A non-limiting example of a “diesel fuel” is composed of a mixture of C₉-C₂₄ hydrocarbons that comprise about 50% to about 95% by volume of aliphatic hydrocarbons, of which about 0% to about 50% by volume are cycloparaffins, about 0% to about 5% by volume of olefinic hydrocarbons, and about 5% to about 50% by volume of aromatic hydrocarbons, and which boil at between about 280° F. (138° C.) and 750° F. (399° C.).

A non-limiting example of a “kerosene” comprises about 5% to about 50% by volume of an aromatic fraction, about 0% to about 50% by volume of a cycloparaffin fraction, and about 0% to about 5% by volume of an olefinic fraction.

A non-limiting example of a “jet fuel” comprises about 0% to about 25% by volume of an aromatic fraction, about 0% to about 25% by volume of a cycloparaffin fraction, and about 0% to about 5% by volume of an olefinic fraction.

Biodiesel blends (biodiesel blended with diesel fuel) have a composition reflective of blend ratio and the diesel chosen for the blend. The biodiesel itself can be made from vegetable oils such as soy, rape, palm, animal fats, used cooking oil, or other sources.

A renewable diesel is made by hydroprocessing vegetable oil or fatty acid methyl esters to saturate the olefin bonds, remove the oxygen atoms, and leave a highly paraffinic hydrocarbon.

A non-limiting example of a “Fischer-Tropsch” derived fuel comprises about 90%-100% by volume of aliphatic hydrocarbons, about 0% to about 1% by volume of olefins, and about 0%-10% by volume of aromatics.

The aromatics fraction of fuels used in methods described herein can contain methyl aromatics and non-methyl alkyl aromatics. Non-limiting examples of non-methyl alkyl aromatics include molecules such as ethylbenzene, propylbenzene, butylbenzene, alkylnaphthalenes, and the like, in which a single alkyl chain containing two or more carbons is bonded to the aromatic ring. Non-limiting examples of methyl aromatics include aromatic molecules such as toluene, o, m, and p-xylenes, trimethylbenzenes, methyl ethylbenzenes, and the like.

The cycloparaffin fraction of fuels used in the methods described herein consists of cycloalkanes or molecules containing at least one cycloalkane ring. Non-limiting examples of components of the cycloparaffin fraction include cyclohexane, cyclopentane, methylcyclohexanes, methylcyclopentane, dimethylcyclohexanes, dimethylcyclopentanes, ethylcyclohexane, and ethylcyclopentane.

The olefinic fraction of fuels used in the methods described herein can contain linear, branched, and cyclo-olefins. Non-limiting examples of components of the olefinic fraction include butenes, pentenes, isopentenes, hexenes, and diisobutylene.

The iso-paraffinic (branched paraffinic) fraction and n-paraffinic (linear paraffinic) fraction of fuels used in the methods described herein consist, respectively, of branched and straight chain alkanes. Non-limiting examples of iso-paraffinic fraction and n-paraffinic fraction components include n-pentane, n-hexane, n-heptane, 2-methylpentane, and iso-octane.

Gasolines used in the methods described herein in some aspects have a (RON+MON)/2 value of between about 85 to about 100 and in some aspects contain less than 1% by volume of benzene and less than 80 ppm by weight of sulfur.

Gasoline-alcohol blends used in the methods described herein in some aspects have a (RON+MON)/2 value of between about 85 to about 105, and in some aspects have a (RON+MON)/2 value of between about 87 to about 93.

Non-limiting examples of a “fuel-alcohol blend” include:
(1) a blend comprising about 5% to about 15% by volume of an alcohol and about 85% to about 95% by volume of a fuel;
(2) a blend Comprising about 15% to about 25% by volume of an alcohol and about 75% to about 85% by volume of a fuel;
(3) a blend comprising about 25% to about 35% by volume of an alcohol and about 65% to about 75% by volume of a fuel;
(4) a blend comprising about 35% to about 45% by volume of an alcohol and about 55% to about 65% by volume of a fuel;
(5) a blend comprising about 45% to about 55% by volume of an alcohol and about 45% to about 55% by volume of a fuel;
(6) a blend comprising about 55% to about 65% by volume of an alcohol and about 35% to about 45% by volume of a fuel;
(7) a blend comprising about 65% to about 75% by volume of an alcohol and about 25% to about 35% by volume of a fuel;
(8) a blend comprising about 75% to about 85% by volume of an alcohol and about 15% to about 25% by volume of a fuel; and
(9) a blend comprising about 85% to about 95% by volume of an alcohol and about 5% to about 15% by volume of a fuel.

“HCCI” refers to any engine or combustion process in which a substantial majority of the fuel charge is premixed with air or combustion product gases (combustion residuals) to a degree sufficient for compression-induced combustion to occur at multiple locations throughout the premixed charge volume.

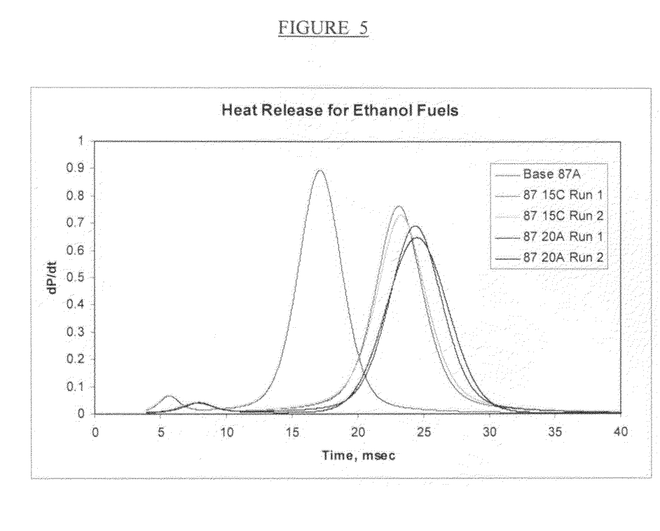

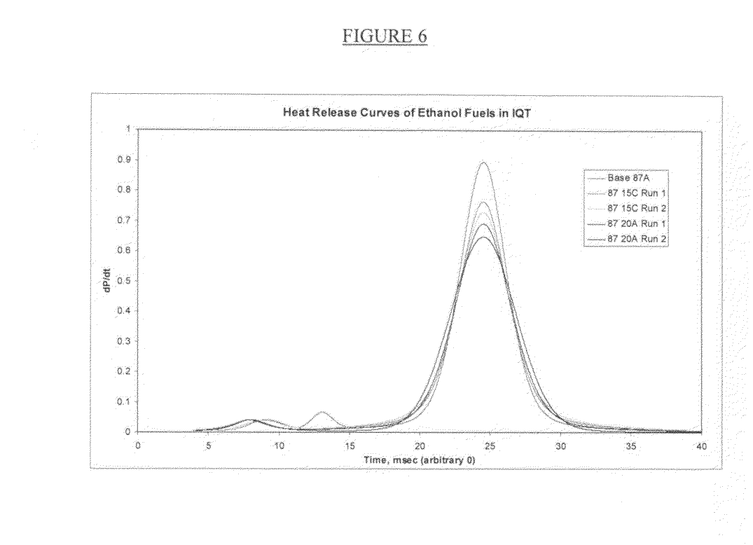

A “heat release time interval” means the time interval between LTHR50 and HTHR50. FIGS. 5 and 6 illustrate heat release data for combustion of ethanol-enriched gasolines in accordance with the methods described herein.

“Ignition delay” is the interval between the time at which the fuel is injected and the time at which auto-ignition actually occurs. The methods described herein achieve ignition delays that are about 20% to about 80% greater than the ignition delays observed for reference fuels combusted under equivalent conditions.

“Initiating engine operation in a spark ignition (SI) mode” means combusting by spark ignition a fuel or air-fuel charge in an engine cylinder to cold-start the engine. The fuel used to initiate engine operation in a spark ignition (SI) mode may be the same or different than the fuel used when the engine converts to an advanced combustion mode (e.g. HCCI mode).

A “reference fuel” (e.g. a “reference gasoline”) is a fuel which does not contain alcohol and which is blended to a similar ignition quality level as the fuel-alcohol blend. For gasoline, the common ignition quality measure is (RON+MON)/2. Other ignition quality measures may also be used such as cetane number, derived cetane number, RON, or other common practice measures.

“Rₘₐₓ” is the HTHR maximum rate of pressure increase.

In one embodiment, an advanced combustion engine's operating envelope in an advanced combustion mode is expanded by supplying an engine cylinder during operation in the advanced combustion mode with a fuel-alcohol blend that comprises about 5%-95% by volume, in some aspects about 5%-85% or 10%-75% by volume, in some aspects about 10%-50% by volume, in some aspects about 10%-30% by volume, in some aspects 11%-30% by volume, in some aspects 11%-25% by volume, in some aspects 15%-25% by volume, and in some aspects about 10%-15% by volume of an alcohol.

In this embodiment, during operation in the advanced combustion mode. In this embodiment, during operation in the advanced combustion mode:(1) the engine's peak NOₓ emission level is between about 5% to about 99% lower than the peak NOₓ emission level generated by combustion of a reference fuel under equivalent combustion conditions; and (2) the engine cylinder optionally contains a small percentage by volume of EGR prior to combustion of the fuel-alcohol blend in the cylinder.

In another embodiment of the methods described herein, an advanced combustion engine's operating envelope in the HCCI mode is expanded by supplying an engine cylinder during operation in the HCCI mode with a fuel-alcohol blend that comprises about 5%-95% by volume, in some aspects about 10%-75% by volume, in some aspects about 10%-50% by volume, in some aspects about 10%-30% by volume, and in some aspects about 10%-15% by volume of an alcohol. In this embodiment, during operation in the advanced combustion mode: (1) the engine's peak NOₓ emission level is between about 5% to about 99% lower than the peak NOₓ emission level generated by combustion of a reference fuel under equivalent combustion conditions; and (2) the engine cylinder optionally contains a small percentage by volume of EGR prior to combustion of the fuel-alcohol blend in the cylinder.

In another embodiment of the methods described herein, an advanced combustion engine's operating envelope in the HCCI mode is expanded by supplying an engine cylinder during operation in the HCCI mode with a gasoline-alcohol blend that comprises a gasoline and about 5%-95% by volume, in some aspects about 10%-75% by volume, in some aspects about 10%-50% by volume, in some aspects about 10%-30% by volume, and in some aspects about 10%-15% by volume of an alcohol (in some aspects ethanol). In this embodiment, during operation in the advanced combustion mode: (1) the engine's peak NOₓ emission level is between about 5% to about 99% lower than the peak NOₓ emission level generated by combustion of a reference gasoline under equivalent combustion conditions; and (2) the engine cylinder optionally contains a small percentage by volume of EGR prior to combustion of the gasoline-alcohol blend in the cylinder.

In another embodiment of the methods described herein, an advanced combustion engine's operating envelope in an advanced combustion mode is expanded by supplying an engine cylinder during operation in the advanced combustion mode with a gasoline-alcohol blend (a) that has a (RON+MON)/2 value of between about 85 to about 100, and (b) that comprises between about 10% to about 30% by volume of an alcohol and about 70% to about 90% by volume of a gasoline. In this embodiment, during operation in the HCCI advanced combustion mode: (1) the engine's peak NOₓ emission level is between about 5% to about 99% lower than the peak NOₓ emission level generated by combustion of a reference gasoline under equivalent combustion conditions; and (2) the engine cylinder optionally contains a small percentage by volume of EGR prior to combustion of the gasoline-alcohol blend in the cylinder.

In another embodiment of the methods described herein, an advanced combustion engine's HCCI operating envelope is expanded by supplying an engine cylinder during operation in the HCCI mode with a gasoline-ethanol blend (a) that has a (RON+MON)/2 value of between about 85 to about 100, and (b) that comprises between about 10% to about 30% by volume of an alcohol and about 70% to about 90% by volume of a gasoline. In this embodiment, during operation in the HCCI mode: (1) the engine's peak NOₓ emission level is between about 5% to about 99% lower than the peak NOₓ emission level generated by combustion of a reference gasoline under equivalent combustion conditions; and (2) the engine cylinder optionally contains a small percentage by volume of EGR prior to combustion of the gasoline-ethanol blend in the cylinder.

In another embodiment of the methods described herein, an advanced combustion engine's HCCI operating envelope is expanded by supplying an engine cylinder during operation in the HCCI mode with a gasoline-ethanol blend (a) that has a (RON+MON)/2 value of between about 85 to about 100 (for example, between about 87 to about 95) and (b) that comprises between about 10% to about 30% by volume of ethanol and about 70% to about 90% by volume of a gasoline. In this embodiment, during operation in the HCCI mode: (1) the engine's peak NOₓ emission level is between about 5% to about 99% lower than the peak NOₓ emission level generated by combustion of a reference gasoline under equivalent combustion conditions; and (2) the engine cylinder does not contain EGR prior to combustion of the gasoline-ethanol blend in the cylinder.

In still another embodiment of the methods described herein, an advanced combustion engine's HCCI operating envelope is expanded by supplying an engine cylinder during operation in the HCCI mode with a gasoline-ethanol blend (a) that has a (RON+MON)/2 value of between about 85 to about 100, and (b) that comprises between about 10% to about 30% by volume of ethanol and about 70% to about 90% by volume of a gasoline. In this embodiment, during operation in the HCCI mode: (1) the engine's peak NOₓ emission level between about about 5% to about 99% lower than the peak NOₓ emission level generated by combustion of a reference gasoline under equivalent combustion conditions; (2) the engine cylinder does not contain EGR prior to combustion of the gasoline-ethanol blend in the cylinder; and (3) the Rₘₐₓ value is approximately equal to or lower than the Rₘₐₓ value observed when a reference gasoline having a (RON+MON)/2 value of between about 87 to about 90 is combusted in the cylinder in the presence of between about 10% to about 40% by volume EGR.

In the methods described herein, the time interval between LTHR and HTHR of a fuel-alcohol blend (e.g. a gasoline-alcohol blend), when compared to a reference fuel (e.g. a reference gasoline) combusted under equivalent conditions, is extended by at least about 20% to about 80%. The time of LTHR of a fuel-alcohol blend (e.g. gasoline-alcohol blend), when compared to the time of LTHR a reference fuel (e.g. a reference gasoline) combusted under equivalent conditions, is extended by at least around 10%. The time of HTHR of a fuel-alcohol blend (e.g. gasoline-alcohol blend), when compared to the time of HTHR for a reference fuel (e.g. a reference gasoline) combusted under equivalent conditions, is extended by at least around 30%.

These and other aspects of the methods described herein are illustrated further in the following examples, which are illustrative and are not limiting.

### EXAMPLES

### Experimental Apparatus and Methods

The following experimental apparatus and methods were used in the experiment of Examples 1 and 2 described below.

An ignition quality tester (IQT) was used to study the combustion characteristics of reference gasolines and gasoline blends listed below in Table IA and Table IB. The IQT used high pressure and temperature conditions to allow an injected fuel aliquot to combust spontaneously. A pressure sensor monitored pressure rise over time and heat release characteristics were quantified, as illustrated in FIGS. 5 and 6. In this manner, combustion was studied under controlled laboratory conditions and fuel differences were characterized. To better simulate HCCI combustion, the standard IQT operation (ASTM D6890) was modified to better replicate HCCI conditions. This was achieved by modifying the combustion chamber temperature and reducing the fuel quantity. These changes allowed the IQT to predict fuel composition effects in line with HCCI engine observations.

### Example 1

### Combustion Characteristics

Compositions and combustion characteristics of five fuels and fuel blends were evaluated and are summarized below in Table IA and Table IB. The fuels and fuel blends were grouped into two octane quality levels: (1) (RON+MON)/2 of about 87, and (2) (RON+MON)/2 of about 90.

TABLE IA

| Sample Name | Base 87A | Base 87A | 87-15C | 87-15C | 87-15C | 87-20A | 87-20A | 87-20A |
|---|---|---|---|---|---|---|---|---|
| Sample Lab. No. | 08-15592 | 08-15592 | 08-19169 | 08-19169 | 08-19169 | 08-15832 | 08-15832 | 08-15832 |
| Run No. | 420 | 423 | 416 | 418 | 424 | 417 | 419 | 425 |
| (RON + MON)/2 | 87.7 | 87.7 | 86.7 | 86.7 | 86.7 | 88.5 | 88.5 | 88.5 |
| RON | 90.6 | 90.6 | 92.0 | 92.0 | 92.0 | 93.2 | 93.2 | 93.2 |
| Ignition Delay, | 14.0 | 12.8 | 20.0 | 20.1 | 19.0 | 21.3 | 21.3 | 19.7 |
| msec | | | | | | | | |
| Low | 5.7 | 6.5 | 7.7 | 7.7 | 8.0 | 7.9 | 7.9 | 8.5 |
| Temperature | | | | | | | | |
| Combustion | | | | | | | | |
| 50% Point | | | | | | | | |
| High | 17.1 | 15.3 | 23.1 | 23.3 | 22.4 | 24.4 | 24.5 | 23.3 |
| Temperature | | | | | | | | |
| Heat Release | | | | | | | | |
| 50% Point | | | | | | | | |
| Delta | 11.4 | 8.9 | 15.4 | 15.6 | 14.3 | 16.5 | 16.6 | 14.9 |
| (HTHR50 - | | | | | | | | |
| LTC50) | | | | | | | | |
| Average Peak | NA | 103.3 | NA | NA | 14.1 | NA | NA | 12.1 |
| NOx | | | | | | | | |

TABLE IB

| Sample Name | Base 90 | 90-20 | 90-20 |
|---|---|---|---|
| Sample Lab. No. | 08-13955 | 08-13956 | 08-13956 |
| Run No. | 421 | 414 | 422 |
| (RON + MON)/2 | 90.1 | 90.6 | 90.6 |
| RON | 95.2 | 97.1 | 97.1 |
| Ignition Delay, msec | 22.0 | 31.4 | 32.5 |
| Low Temperature Combustion | 7.8 | 9.4 | 9.7 |
| 50% Point | | | |
| High Temperature Heat Release | 26.1 | 34.7 | 36.3 |
| 50% Point | | | |
| Delta (HTHR50 − LTC50) | 18.3 | 25.3 | 26.6 |
| Average Peak NOx | 12.3 | NA | 10.6 |

TABLE II

| Sample Name | Base 90 | 90-20 | Base 87A | 87-15C | 87-20A |
|---|---|---|---|---|---|
| Sample Lab. No. | 08-13955 | 08-13956 | 08-15592 | 08-19169 | 08-15832 |
| (RON + MON)/2 | 90.1 | 90.6 | 87.7 | 86.7 | 88.5 |
| RON | 95.2 | 97.1 | 90.6 | 92.0 | 93.2 |
| Ignition Delay, msec | 22.0 | 32.0 | 13.4 | 19.7 | 20.8 |
| Low Temperature | 7.8 | 9.6 | 6.1 | 7.8 | 8.1 |
| Combustion 50% Point, | | | | | |
| msec | | | | | |
| High Temperature Heat | 26.1 | 35.5 | 16.2 | 22.9 | 24.1 |
| Release 50% Point, msec | | | | | |
| Delta (HTHR50 - | 18.3 | 25.9 | 10.2 | 15.1 | 16.0 |
| LTC50), msec | | | | | |

The combustion data summarized in Tables IA, IB and II demonstrate that including more than 10% by volume of ethanol in gasoline significantly improved the combustion performance of the fuels studied in the IQT test.

For each group of fuels, it might have been expected that heat release and ignition delay would occur at about the same time, since each group had matched octane quality levels. For example, in the higher octane group, Base 90 had a (RON+MON)/2 of 90.1 and Fuel 90-20 had a (RON+MON)/2 of 90.6, values which are essentially the same. Yet, the center of the main combustion event (High Temperature Heat Release 50% Point (HTHR50)) was 26.1 msec for Base 90 and averaged 35.5 msec for Fuel 90-20, a substantial 36% increase in time. The ignition delay also shows a substantial 45% increase from 22.0 msec for Base Fuel 90 to average of 32.0 msec for Fuel 90-20.

The same surprising trend was seen in the fuels blended to (RON+MON)/2 of about 87. The HTHR50 time point increased by 41% and 48%, respectively, for Fuel 87-15C and Fuel 87-20A when compared to Base 87A. The ignition delay increased by 47% and 55% for the same fuels.

The time of LTHR50 was also delayed with the ethanol containing fuels, although this delay was not as pronounced as the HTHR50 time point delay. Consequently, the time interval between LTHR50 and HTHR50 for the ethanol containing fuels was greater than the time interval between LTHR50 and HTHR50 for the base fuels. When compared to the base fuel, the time differential between the low temperature and high temperature heat release points: (1) was about 49% higher for the fuel containing 15% ethanol; (2) was about 57% higher for the 87 (RON+MON)/2 fuel containing 20% ethanol; and (3) was about 41% higher for the 90 (RON+MON)/2 fuel containing 20% ethanol. The data obtained indicated excellent repeatability for the combustion tests conducted.

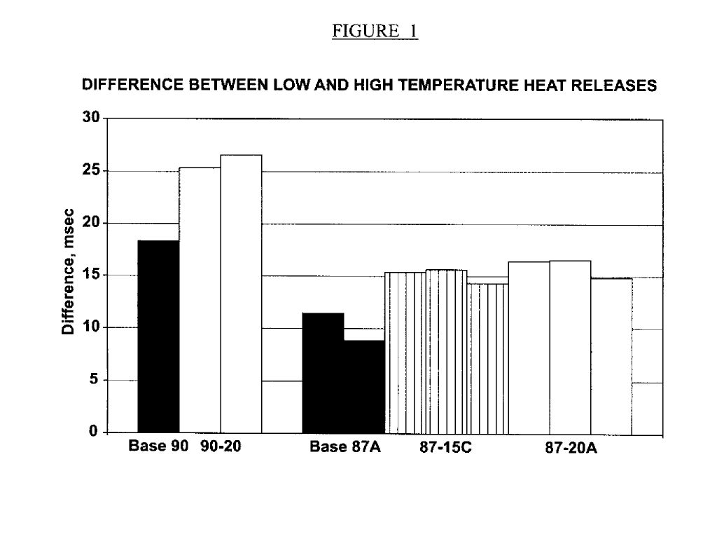

FIG. 1 illustrates the aforementioned differences between HTHR50 and LTHR50 for the base (ethanol-free) and ethanol-containing fuels. The data shown in FIG. 1 demonstrate that there is a longer time interval between the low and high temperature heat release points for the fuels containing more than 10% ethanol when compared to a fuel without ethanol that has about the same (RON+MON)/2 value. This longer time interval probably provides an opportunity for some hot reactive gases to mix uniformly in the cylinder before the main combustion event and the presence of such reactive gases could assist with combustion phasing or auto-ignition in challenging environments. Thus, the unusual combustion characteristics of the processes of the invention could also enable engine designers to better optimize injection timing.

### Example 2

### The Effect of Fuel Composition on Peak NOₓ Emission Levels

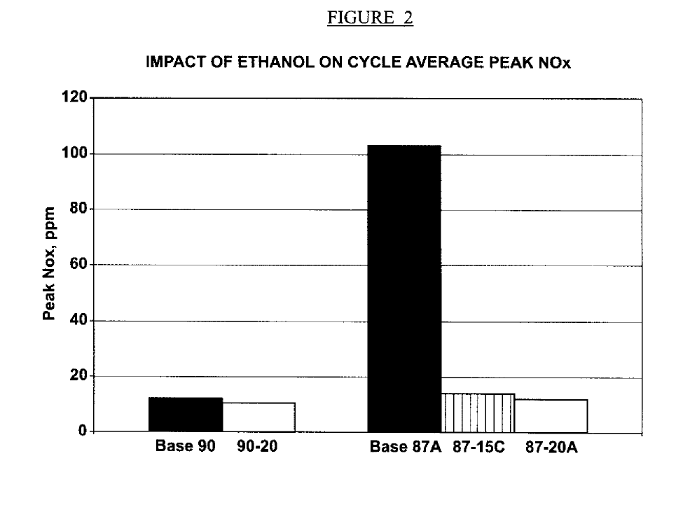

During the combustion experiments described in Example 1, the impact of ethanol on peak NOₓ emission levels was also studied. FIG. 2 illustrates the effect of ethanol on cycle average peak NOₓ emission levels for the base (ethanol-free) and ethanol-containing fuels, as averaged over thirty-two test cycles.

The use of 15% or more ethanol reduced cycle average peak NOₓ levels by about 86-89% at 87 (RON+MON)/2 and 14% at 90 (RON+MON)/2. While both sets of fuels at lower and higher octane levels saw significant NOx reduction, the result for the 87 (RON+MON)/2 fuel is an impressively large reduction. It is theorized that at the lower octane number, use of the non-ethanol fuel results in a not completely homogeneous fuel/air mixture. This can lead to less efficient combustion, increased peak combustion temperatures, and locally hot zones. NOₓ formation is very temperature-dependent, and tends to increase significantly with increasing peak combustion temperatures. It is believed that ethanol delays combustion long enough to significantly improve the homogeneity of the fuel mixture, thereby reducing both combustion temperatures and NOₓ levels. The fact that the NOₓ level decrease is smaller with the higher octane fuels supports this conclusion. With the higher octane base fuel (Base 90), the HTHR50 is already noticeably delayed at 26.1 msec. A further delay of HTHR50 to 35.5 msec in Fuel 90-20 does not impact the homogeneity nearly as much as with the lower octane fuel set, where the Base 87A HTHR50 is only 16.2 msec.

It was determined that the Base Fuel 90 and Fuel 87-20A had similar peak NOₓ emission levels (12.3 ppm for Base Fuel 90 and 12.1 ppm for Fuel 87-20A). This was surprising as the composition, octane quality, HTHR50, and ignition delays of Base Fuel 90 and Fuel 87-20A, when considered together, would have suggested that Fuel 87-20A should have a higher peak NOₓ emission level than Base Fuel 90. (Base Fuel 90 and Fuel 87-20A have substantially different compositions: Base Fuel 90 does not contain ethanol and Fuel 87-20A contains 20% ethanol. The octane quality as measured by (RON+MON)/2 is 90.1 for Base Fuel 90 and 88.5 for Fuel 87-20A. The HTHR50 (26.1 msec) and ignition delay (22.0 msec) for Base Fuel 90 is somewhat later than the HTHR50 (24.1 msec) and ignition delay (20.8 msec) for Fuel 87-20A.) The similarity between the peak NOₓ emission levels of Base Fuel 90 and Fuel 87-20A unexpected shows that HCCI peak NOₓ emission levels can be effectively reduced by either increasing the octane level of the fuel (by 2-3 numbers) on the (RON+MON)/2 scale or by blending the lower octane fuel with (about 20%) ethanol.

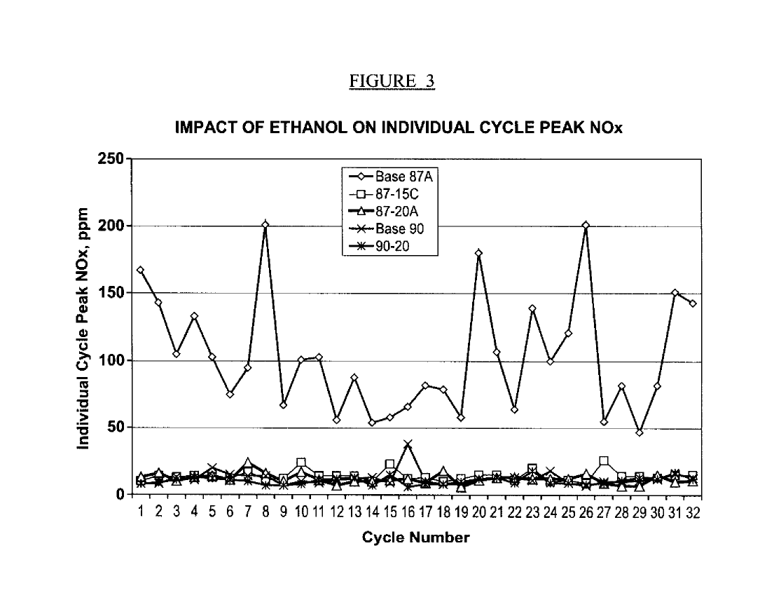

FIG. 3 illustrates the effect of ethanol on individual cycle peak NOₓ emission levels for the base (ethanol-free) and ethanol-containing fuels tested in each of the thirty-two test cycles of the combustion experiments described in Example 1. Not only were the base fuel values substantially higher than the corresponding ethanol fuel values, but the cycle-to-cycle variability of the base fuel was significantly higher than for the ethanol fuels, indicating that ethanol-containing fuels achieve a more stable combustion.

It is to be understood that the above description is intended for illustrative purposes only and is not intended to limit the scope of the present invention in any way.

What is claimed is:

1. A method of expanding an advanced combustion engine's operating envelope during operation in an advanced combustion mode, the method comprising supplying an engine cylinder during operation in the advanced combustion mode with a fuel-alcohol blend that comprises about 5% or more by volume of an alcohol.

2. The method of claim 1, wherein the fuel-alcohol blend is selected from the group consisting of:
(a) a blend comprising about 5% to about 15% by volume of an alcohol and about 85% to about 95% by volume of a fuel;
(b) a blend comprising about 15% to about 25% by volume of an alcohol and about 75% to about 85% by volume of a fuel;
(c) a blend comprising about 25% to about 35% by volume of an alcohol and about 65% to about 75% by volume of a fuel;
(d) a blend comprising about 35% to about 45% by volume of an alcohol and about 55% to about 65% by volume of a fuel;
(e) a blend comprising about 45% to about 55% by volume of an alcohol and about 45% to about 55% by volume of a fuel;
(f) a blend comprising about 55% to about 65% by volume of an alcohol and about 35% to about 45% by volume of a fuel;
(g) a blend comprising about 65% to about 75% by volume of an alcohol and about 25% to about 35% by volume of a fuel;
(h) a blend comprising about 75% to about 85% by volume of an alcohol and about 15% to about 25% by volume of a fuel; and
(i) a blend comprising about 85% to about 95% by volume of an alcohol and about 5% to about 15% by volume of a fuel.

3. The method of claim 1, wherein the fuel-alcohol blend is a gasoline-alcohol blend that has a (RON+MON)/2 value of between about 85 to about 100 and that comprises about 10% to about 50% by volume of an alcohol.

4. The method of claim 1, wherein:
(a) the advanced combustion engine operates in either a HCCI mode, a PCCI mode, or a LTC mode; and
(b) the fuel-alcohol blend comprises a fuel selected from the group consisting of a gasoline, a diesel fuel, a kerosene, a jet fuel, a biofuel blend, a Fischer-Tropsch derived fuel, a gasoline-diesel blend, a naphtha, and mixtures and/or blends thereof.

5. The method of claim 1, wherein:
(a) the fuel-alcohol blend comprises a gasoline;
(b) the engine operates in a HCCI mode; and
(c) the engine's peak NOₓ emission level is between about 5% to about 99% lower than the peak NOₓ emission level generated by combustion of a reference gasoline under equivalent combustion conditions.

6. The method of claim 1, wherein:
(a) the fuel-alcohol blend comprises a gasoline;
(b) the engine operates in a HCCI mode; and
(c) the time interval between LTHR and HTHR is at least about 20% to about 80% longer than the time interval between LTHR and HTHR observed when a reference gasoline is combusted under equivalent combustion conditions.

7. The method of claim 1, wherein:
(a) the fuel-alcohol blend comprises a gasoline;
(b) the engine operates in a HCCI mode; and
(c) the engine's ignition delay is at least about 20% to about 80% longer than the ignition delay observed when a reference gasoline is combusted under equivalent combustion conditions.

8. The method of claim 1, wherein:
(a) the fuel-alcohol blend comprises a gasoline;
(b) the engine operates in a HCCI mode;
(c) the engine's peak NOₓ emission level is between about 5% to about 99% lower than than peak NOₓ emission level generated by combustion of a reference gasoline under equivalent combustion conditions; and
(d) the engine cylinder does not contain EGR prior to combustion of the gasoline-ethanol blend in the cylinder.

9. The method of claim 1, wherein the fuel-alcohol blend comprises a gasoline and a monohydric aliphatic alcohol.

10. The method of claim 1, wherein the fuel-alcohol blend comprises a gasoline and two or more alcohols.

11. The method of claim 1, wherein the fuel-alcohol blend comprises a gasoline and an alcohol selected from the group consisting of methanol, ethanol, 1-propanol, 2-propanol, 1-butanol, 2-butanol, 2-methyl-1-propanol, and 2-methyl-2-propanol.

12. The method of claim 1, wherein the fuel-alcohol blend comprises a gasoline-alcohol blend and the gasoline and alcohol are supplied separately to, and form a blend within, the cylinder.

13. The method of claim 1, wherein engine operation is initiated in a SI mode and converts to operation in a HCCI mode in response to a change in engine load.

14. The method of claim 5, wherein the fuel-alcohol blend comprises a gasoline-ethanol blend and the engine's HCCI operating envelope includes loads that are about 10% to about 30% higher than those achieved when the engine operates in a HCCI mode using a reference gasoline.

15. The method of claim 14, wherein engine operation is initiated in a SI mode and converts to operation in a HCCI mode in response to a change in engine load.

16. A method of expanding a HCCI engine's operating envelope, the method comprising supplying an engine cylinder during operation in the HCCI mode with a gasoline-alcohol blend (a) that has a (RON+MON)/2 value of between about 85 to about 105, and (b) that comprises between about 5% to about 95% by volume of an alcohol about 70% to about 90% by volume of a gasoline, wherein:
(1) the engine's peak NOₓ emission level is between about 5% to about 99% lower than than the peak NOₓ emission level generated by combustion of a reference gasoline under equivalent combustion conditions;
(2) the time interval between LTHR and HTHR is at least about 20% to about 80% longer than the time interval between LTHR and HTHR observed when a reference gasoline is combusted under equivalent combustion conditions;
(3) ignition delay is at least about 20% to about 80% longer than the ignition delay observed when a reference gasoline is combusted under equivalent combustion conditions; and
(4) the Rₘₐₓ value is approximately equal to or lower than the Rₘₐₓ value observed when a reference gasoline having a (RON+MON)/2 value of between about 87 to about 90 is combusted in the cylinder.

17. The method of claim 16, wherein the gasoline-alcohol blend comprises about 10% to about 75% by volume of an alcohol.

18. The method of claim 16, wherein the gasoline-alcohol blend comprises about 10% to about 50% by volume of an alcohol.

19. The method of claim 16, wherein the gasoline-alcohol blend comprises about 10% to about 30% by volume of an alcohol.

20. The method of claim 16, wherein the gasoline-alcohol blend comprises about 10% to about 15% by volume of an alcohol.

21. The method of claim 16, wherein the engine's HCCI operating envelope includes loads that are about 10% to about 30% higher than those achieved when the engine operates in a HCCI mode using a reference gasoline.

22. A method of reducing an advanced combustion engine's peak NOₓ emission level, the method comprising supplying an engine cylinder during operation in an advanced combustion mode with a fuel-alcohol blend that comprises about 5% or more by volume of an alcohol.

23. The method of claim 22, wherein:
(a) the fuel-alcohol blend is a gasoline-alcohol blend which comprises about 5% to about 95% by volume of an alcohol;
(b) the engine operates in a HCCI mode;
(c) the engine's peak NOₓ emission level is between about 5% to about 99% lower than than the peak NO emission level generated by combustion of a reference gasoline under equivalent combustion conditions; and
(d) the engine's HCCI operating envelope includes loads that are about 10% to about 30% higher than those achieved when the engine operates in a HCCI mode using a reference gasoline.

24. The method of claim 22, wherein the fuel-alcohol blend is a gasoline-alcohol blend which comprises about 10% to about 75% by volume of an alcohol.

25. The method of claim 22, wherein the fuel-alcohol blend is a gasoline-alcohol blend which comprises about 10% to about 50% by volume of an alcohol.

26. The method of claim 22, wherein the fuel-alcohol blend is a gasoline-alcohol blend which comprises about 10% to about 30% by volume of an alcohol.

27. The method of claim 16, wherein the fuel-alcohol blend is a gasoline-alcohol blend which comprises about 11% to about 30% by volume of an alcohol.

28. The method of claim 16, wherein the fuel-alcohol blend is a gasoline-alcohol blend which comprises about 11% to about 25% by volume of an alcohol.

29. The method of claim 16, wherein the fuel-alcohol blend is a gasoline-alcohol blend which comprises about 15% to about 25% by volume of an alcohol.

30. The method of claim 22, wherein the fuel-alcohol blend is a gasoline-alcohol blend which comprises about 10% to about 15% by volume of an alcohol.

31. The method of claim 22, wherein:
(a) the gasoline-alcohol blend comprises about 10% to about 30% by volume of an alcohol;
(b) the time interval between LTHR and HTHR is at least about 20% to about 80% longer than the time interval between LTHR and HTHR observed when a reference gasoline is combusted under equivalent combustion conditions; and
(c) the engine's ignition delay is at least about 20% to about 80% longer than the ignition delay observed when a reference gasoline is combusted under equivalent combustion conditions.

32. The method of claim 22, wherein the fuel-alcohol blend is a gasoline-ethanol blend which comprises about 10% to about 30% by volume of ethanol and the engine's peak NOₓ emission level is between about 5% to about 99% lower than than the peak NOₓ emission level generated by combustion of a reference gasoline under equivalent combustion conditions.

33. The method of claim 22, wherein:
(a) the fuel-alcohol blend is a gasoline-ethanol blend which comprises about 10% to about 30% by volume of ethanol;
(b) the engine's peak NOx emission level is between about 5% to about 99% lower than than the peak NOx emission level generated by combustion of a reference gasoline under equivalent combustion conditions;
(c) the time interval between LTHR and HTHR is at least about 20% to about 80% longer than the time interval between LTHR and HTHR observed when a reference gasoline is combusted under equivalent combustion conditions; and
(d) gasoline-ethanol blend has a (RON+MON)/2 value of between about 85 to about 95.

34. The method of claim 22, wherein the fuel-alcohol blend is a s gasoline-alcohol blend which comprises about 11% to about 30% by volume of an alcohol.

35. The method of claim 22, wherein the fuel-alcohol blend is a gasoline-alcohol blend which comprises about 11% to about 25% by volume of an alcohol.

36. The method of claim 22, wherein the fuel-alcohol blend is a gasoline-alcohol blend which comprises about 15% to about 25% by volume of an alcohol.

37. A method of reducing cycle-to-cycle variability in an advanced combustion engine, the method comprising supplying an engine cylinder during operation in an advanced combustion mode with a fuel-alcohol blend that comprises about 5% or more by volume of an alcohol.

38. The method of claim 37, wherein:
(a) the fuel-alcohol blend is a gasoline-alcohol blend which comprises about 5% to about 95% by volume of an alcohol;
(b) the engine operates in a HCCI mode;
(c) the engine's peak NOx emission level is between about 5% generated by combustion of a reference gasoline under equivalent combustion conditions; and
(d) the engine's HCCI operating envelope includes loads that are about 10% to about 30% higher than those achieved when the engine operates in a HCCI mode using a reference gasoline.

39. The method of claim 37, wherein the fuel-alcohol blend is a to gasoline-alcohol blend which comprises about 10% to about 75% by volume of an alcohol.

40. The method of claim 37, wherein the fuel-alcohol blend is a gasoline-alcohol blend which comprises about 10% to about 50% by volume of an alcohol.

41. The method of claim 37, wherein the fuel-alcohol blend is a gasoline-alcohol blend which comprises about 10% to about 30% by volume of an alcohol.

42. The method of claim 37, wherein the fuel-alcohol blend is a gasoline-alcohol blend which comprises about 11% to about 30% by volume of an alcohol.

43. The method of claim 37, wherein the fuel-alcohol blend is a gasoline-alcohol blend which comprises about 11% to about 25% by volume of an alcohol.

44. The method of claim 37, wherein the fuel-alcohol blend is a gasoline-alcohol blend which comprises about 15% to about 25% by volume of an alcohol.

45. The method of claim 37, wherein the fuel-alcohol blend is a gasoline-alcohol blend which comprises about 10% to about 15% by volume of an alcohol.

46. The method of claim 37, wherein:
(a) the gasoline-alcohol blend comprises about 10% to about 30% by volume of an alcohol;
(b) the time interval between LTHR and HTHR is at least about 20% to about 80% longer than the time interval between LTHR and HTHR observed when a reference gasoline is combusted under equivalent combustion conditions; and
(c) the engine's ignition delay is at least about 20% to about 80% longer than the ignition delay observed when a reference gasoline is combusted under equivalent combustion conditions.

47. The method of claim 37, wherein the fuel-alcohol blend is a gasoline-ethanol blend which comprises about 10% to about 30% by volume of ethanol and the engine's peak NOₓ emission level is between about 5% to about 99% lower than than the peak NOₓ emission level generated by combustion of a reference gasoline under equivalent combustion conditions.

48. The method of claim 37, wherein:
(a) the fuel-alcohol blend is a gasoline-ethanol blend which comprises about 10% to about 30% by volume of ethanol;
(b) the engine's peak NOx emission level is between about 5% to about 99% lower than than the peak NOx emission level generated by combustion of a reference gasoline under equivalent combustion conditions;
(c) the time interval between LTHR and HTHR is at least about 20% to about 80% longer than the time interval between LTHR and HTHR observed when a reference gasoline is combusted under equivalent combustion conditions; and
(d) the gasoline-ethanol blend has a (RON+MON)/2 value of between about 85 to about 95.
